(19) United States
(12) Patent Application Publication
(10) Pub. No.: US 2005/0254820 A1
(43) Pub. Date: Nov. 17, 2005

(54) Optical wireless access systems

(76) Inventors: Feng Qing Zhou, San Jose, CA (US); Jonathan Yu Zhang, Cupertino, CA (US); Mark G. Reichenbach, Pleasanton, CA (US)

Correspondence Address: HELLER EHRMAN LLP, 275 MIDDLEFIELD ROAD, MENLO PARK, CA, 94025-3506, US

(21) Appl. No.: 10/845,768

(22) Filed: May 14, 2004

(51) Int. Cl. H04J 14/02

(52) U.S. Cl. 398/83

(57) ABSTRACT

An optical access system includes a plurality of CWDM converters. A CWDM demux is coupled to at least a portion of the plurality of the CWDM converters. A CWDM mux is coupled to at least a portion of the plurality of the CWDM converters. An optical circulator, or a wideband splitter, is coupled to the demux and the mux by a single fiber. A first CWDM add/drop device is coupled to the optical circulator, or the wideband splitter, and to a first coupler. A first CWDM converter is coupled to the first coupler. A wireless access point is coupled to the CWDM converter.

### BACKGROUND OF THE INVENTION

1. Field of the Invention

This invention is directed to optical wireless access systems, and more particularly optical wireless access systems that bridge Wi-Fi/WIMAX with high capacity fiber networks using CWDM.

2. Description of the Related Art

Today, carriers and bandwidth providers fail to provide cost-effective, flexible and timely broadband access solution to small and medium business (“SMB”) above T1+ data rates. T1 service is costly to attract small to medium business and has a long waiting time to implement. DSL service does not guarantee the bandwidth and is location dependent. DSL does not effectively support T1+ service to customers. End-to-end fiber based solutions are costly and only address 10% of the total SMB market.

Existing public Wi-Fi/WIMAX equipment is bandwidth limited to T1, DSL, or cable modem capacity on public access points, also called as Hotspots). Existing public Wi-Fi/WIMAX equipment is relegated to lower bandwidth connection on public access points and does not scale effectively due to bandwidth limitations.

FIG. 1 illustrates a current xDSL connection that is feed into an access point. At the central office side of the xDSL connection, it connects to a DSLAM (DSL access multiplexer). A DSL modem is at the access point side. Higher bandwidth to this access point can be obtained by a direct point to point fiber link which is too costly.

There is a need for optical access systems that remove the bandwidth bottleneck which hinders the applications of wireless systems in the enterprise and corporation markets. There is a further need for optical access systems that economically deliver data services to small and medium business customers beyond T1/E1. There is a further need for optical access systems with low cost of ownership.

### SUMMARY OF THE INVENTION

Accordingly, an object of the present invention is to provide optical access systems that remove the bandwidth bottleneck which hinders the applications of wireless systems in the enterprise and corporation markets.

Another object of the present invention is to provide optical access systems that economically deliver data services to small and medium business customers beyond T1/E1.

Yet another object of the present invention is to provide optical access systems with low cost of ownership.

A further object of the present invention is to provide optical access systems with a full list of features such as bandwidth, security, management and provisioning.

Another object of the present invention is to provide optical access systems suitable for other services including but not limited to VoIP, video streaming, video on demand, and the like.

These and other objects of the present invention are achieved in an optical access system with a plurality of CWDM converters. A CWDM demux is coupled to at least a portion of the plurality of the CWDM converters. A CWDM mux is coupled to at least a portion of the plurality of the CWDM converters. An optical circulator, or a wideband splitter, is coupled to the demux and the mux by a single fiber. A first CWDM add/drop device is coupled to the optical circulator, or the wideband splitter, and to a first coupler. A first CWDM converter is coupled to the first coupler. A wireless access point is coupled to the CWDM converter.

In another embodiment of the present invention, an optical access system includes a plurality of CWDM converters. A CWDM demux is coupled to at least a portion of the plurality of the CWDM converters. A CWDM mux is coupled to at least a portion of the plurality of the CWDM converters. An optical circulator, or a wideband splitter, is coupled to the demux and the mux by a single fiber. A first CWDM add/drop device is coupled to the optical circulator, or the wideband splitter, and to a first coupler. A first CWDM converter is coupled to the first coupler and a free space optical access assembly is coupled to the CWDM converter.

In another embodiment of the present invention, an optical access system includes a plurality of CWDM converters. A CWDM demux is coupled to at least a portion of the plurality of the CWDM converters. A CWDM mux is coupled to at least a portion of the plurality of the CWDM converters. A first CWDM add/drop device is coupled to the CWDM mux and the CWDM demux with a single fiber ring. A second CWDM add/drop device is coupled to the CWDM mux and the CWDM demux with the single fiber ring. A first CWDM converter is coupled to the first and second CWDM add/drop devices and a wireless access point.

In another embodiment of the present invention, an optical access system includes a plurality of CWDM converters and at least one CWDM GigE converter. A CWDM demux is coupled to at least a portion of the plurality of the CWDM converters. A CWDM mux is coupled to at least a portion of the plurality of the CWDM converters. The CWDM GigE converter is coupled to at least one of the CWDM demux or the CWDM mux. An optical circulator, or a wideband splitter, is coupled to the CWDM demux and the CWDM mux by first and second fibers. A first CWDM add/drop device is coupled to the optical circulator, or the wideband splitter, and to a first coupler. A first CWDM converter is coupled to the first coupler. A free space optical access assembly, or a wireless access point, is coupled to the CWDM converter. A second CWDM add/drop device is coupled to the optical circulator, or the wideband splitter, and to a second coupler. A first CWDM GigE converter is coupled to the second coupler and to a GigE switch or a GigE router. A first optical access system is coupled to the GigE switch or a GigE router.

In another embodiment of the present invention, an optical access system includes a plurality of CWDM converters and at least one CWDM GigE converter. A CWDM demux is coupled to at least a portion of the plurality of the CWDM converters. A CWDM mux is coupled to at least a portion of the plurality of the CWDM converters. The CWDM GigE converter is coupled to at least one of the CWDM demux or the CWDM mux. An optical circulator, or a wideband splitter, is coupled to the demux and the mux by first and second fibers. A first CWDM add/drop device is coupled to the optical circulator or the wideband splitter and to a first coupler. A first CWDM GigE converter is coupled to the first coupler. A first GigE switch or router is coupled to the first CWDM GigE converter. A second CWDM add/drop device is coupled to the optical circulator, or the wideband splitter, and to a second coupler. A second CWDM GigE converter is coupled to the second coupler and to a second GigE switch or a GigE router. A first optical access system is coupled to the GigE switch or a GigE router.

### BRIEF DESCRIPTION OF THE FIGURES

FIG. 1 is a schematic diagram illustrating a current xDSL connection that is feed into an access point.

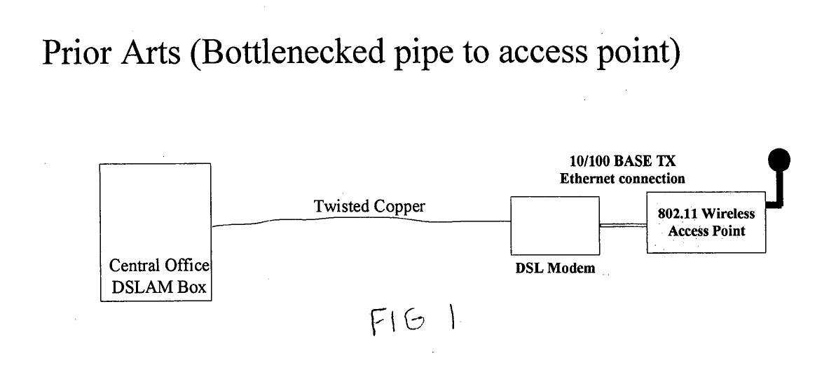

FIG. 2 is a schematic diagram illustrating one embodiment of a single fiber optical wireless access system of the present invention.

FIG. 3 is a schematic diagram illustrating another embodiment of a single fiber optical wireless access system of the present invention.

FIG. 4 is a schematic diagram illustrating one embodiment of a single fiber ring optical wireless access system of the present invention.

FIG. 5 is a schematic diagram illustrating one embodiment of another single fiber ring optical wireless access system of the present invention.

FIG. 6 is a schematic diagram illustrating another embodiment of a single fiber optical wireless access system with CWDM GigE converters of the present invention.

FIG. 7 is a schematic diagram illustrating one embodiment of a deployment structure using any of the FIG. 2-6 systems.

FIG. 8 is a schematic diagram illustrating another embodiment of a deployment structure using any of the FIG. 2-6 systems.

FIG. 9 is a schematic diagram illustrating one embodiment of a legacy system with broadband wireless access service of the present invention with a single fiber.

FIG. 10 is a schematic diagram illustrating another embodiment of a legacy system with broadband wireless access service of the present invention with a single fiber ring.

FIG. 11 is a schematic diagram illustrating another embodiment of a legacy system with broadband wireless access service of the present invention with a single fiber ring.

FIG. 12(a) is a schematic diagram illustrating one embodiment of the present invention of a backup scheme for fiber optic wireless access systems where the fiber is not cut.

FIG. 12(b) is a schematic diagram illustrating one embodiment of the present invention of a backup scheme for fiber optic wireless access systems where the fiber is cut.

FIG. 13 is a schematic diagram of one embodiment of a backup scheme of the present invention for fiber optic wireless access systems with fiber cut backup.

### DETAILED DESCRIPTION OF THE PREFERRED EMBODIMENT

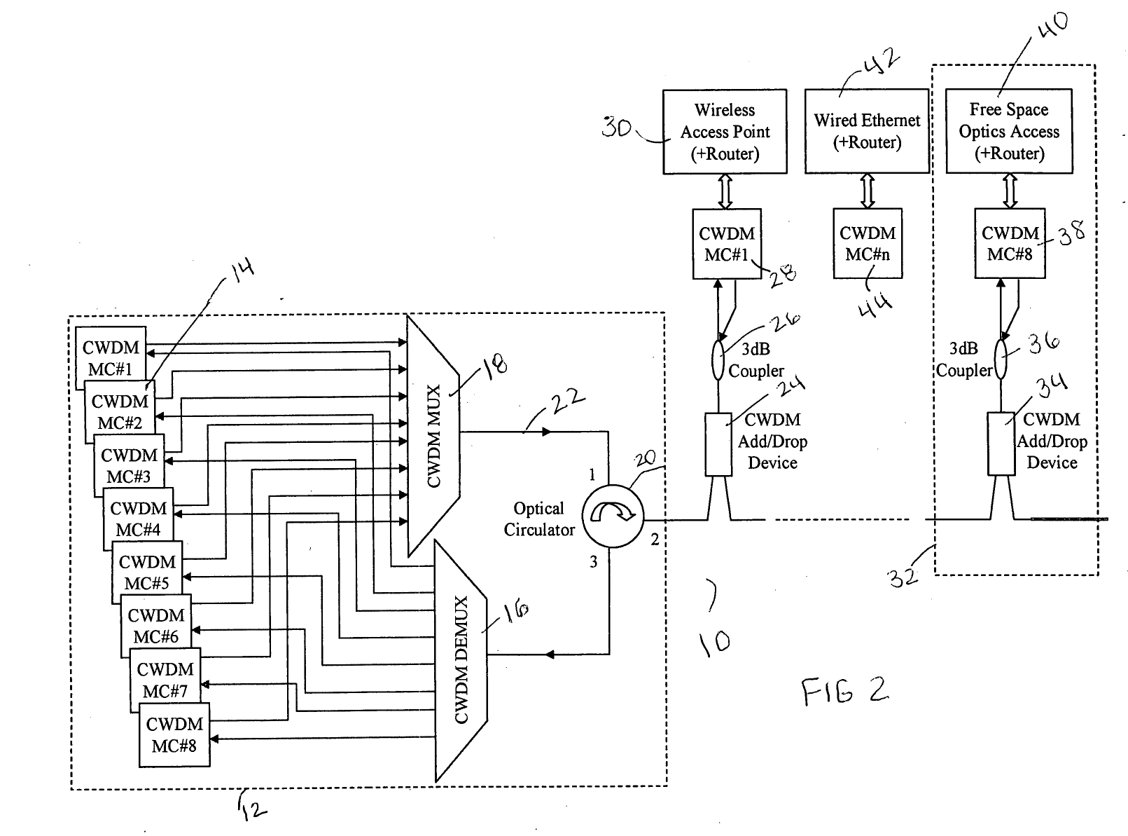

As illustrated in FIG. 2, one embodiment of the present invention is an optical wireless access system 10 that includes a central office mux 12. Central office mux 12 has a plurality of CWDM converters 14. A CWDM demux 16 is coupled to at least a portion of the plurality of the CWDM converters 14. A CWDM mux 18 is coupled to at least a portion of the plurality of the CWDM converters 14. An optical circulator or a wideband splitter, generally denoted as 20, is coupled to demux 16 and mux 18 by a single fiber 22.

A first CWDM add/drop device 24 is coupled to optical circulator or wideband splitter 20 and to a first coupler 26. A first CWDM converter 28 coupled to first coupler 26. A wireless access point 30 is coupled to first CWDM converter 28.

System 10 can also include an access point 32. Access point 32 includes a second CWDM add/drop device 34 coupled to optical circulator or the wideband splitter 20, and to a second coupler 36. A second CWDM converter 38 is coupled to second coupler 36. A free space optical access assembly 40 is coupled to second CWDM converter 38. Free space optical access assembly 40 provides a free space beam that operates in a point to point mode. An Ethernet connection port 42 can also be included and is coupled to a third CWDM converter 44.

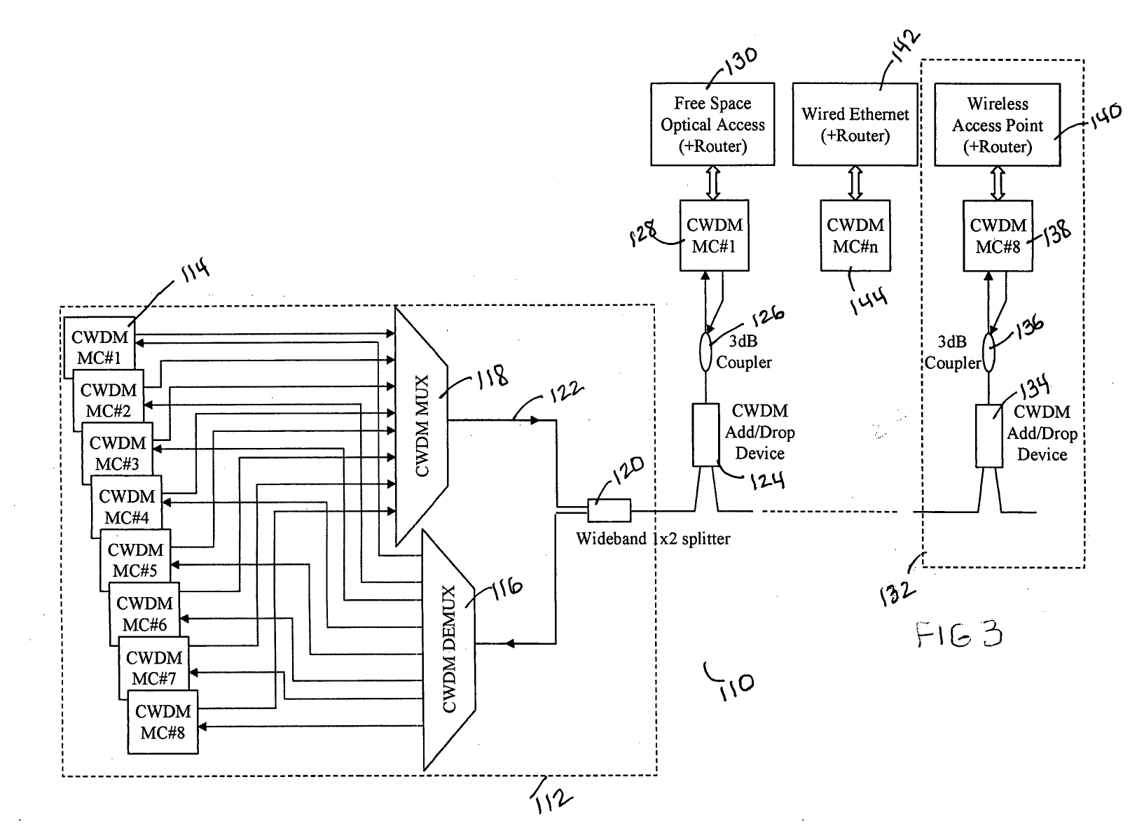

In another embodiment, illustrated in FIG. 3, an optical wireless access system 110 includes a central office mux 112. Central office mux 112 includes a plurality of CWDM converters 114. A CWDM demux 116 is coupled to at least a portion of the plurality of the CWDM converters 114. A CWDM mux 118 is coupled to at least a portion of the plurality of the CWDM converters 114. An optical circulator or a wideband splitter 120 is coupled to demux 116 and mux 118 by a single fiber 122.

A first CWDM add/drop device 124 is coupled to optical circulator or wideband splitter 120 and to a first coupler 126. A first CWDM converter 128 is coupled to first coupler 126. A free space optical access assembly 130 coupled to first CWDM converter 128.

System 110 can include an access point 132 with a second CWDM add/drop device coupled 134 coupled to optical circulator or the wideband splitter 120, and to a second coupler 136. A second CWDM converter 138 is coupled to second coupler 136 and a wireless access point 140. An Ethernet connection port 142 can be provided and coupled to a third CWDM converter 144.

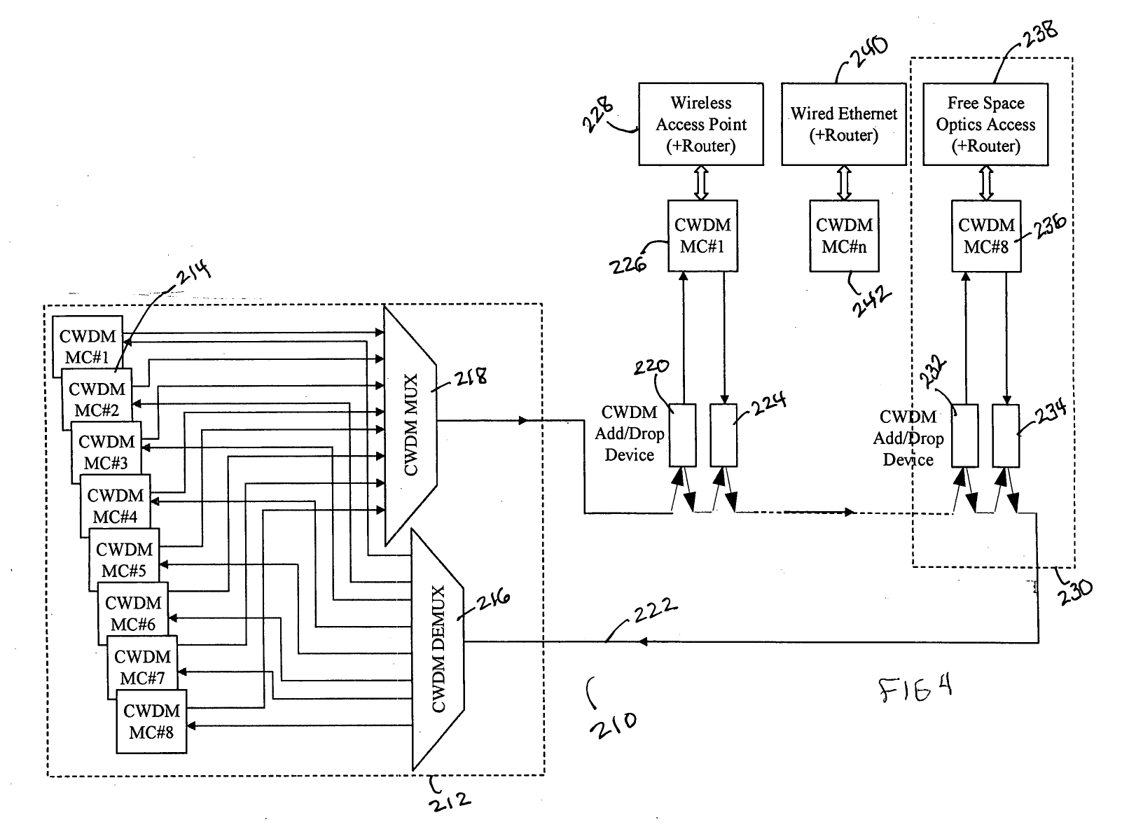

FIG. 4 illustrates another embodiment of the present invention of an optical wireless access system 210 includes a central office mux 212 that includes a plurality of CWDM converters 214. A CWDM demux 216 is coupled to at least a portion of the plurality of the CWDM converters 214. A CWDM mux 218 is coupled to at least a portion of the plurality of the CWDM converters 214. A first CWDM add/drop device 220 is coupled to CWDM mux 218 and CWDM demux 216 with a single fiber ring 222. A second CWDM add/drop device 224 is coupled to CWDM mux 218 and CWDM demux 216 with single fiber ring 222. A first CWDM converter 226 coupled to first and second CWDM add/drop devices 220 and 224, and to a wireless access point 228.

Central office mux 212 can be coupled to an access point 230. Access point 230 includes third and fourth CWDM add/drop devices 232 and 234, and a second CWDM converter 236 that is coupled to a free space optics access 238.

An Ethernet connection port 240 can be provided and coupled to a third CWDM converter 242.

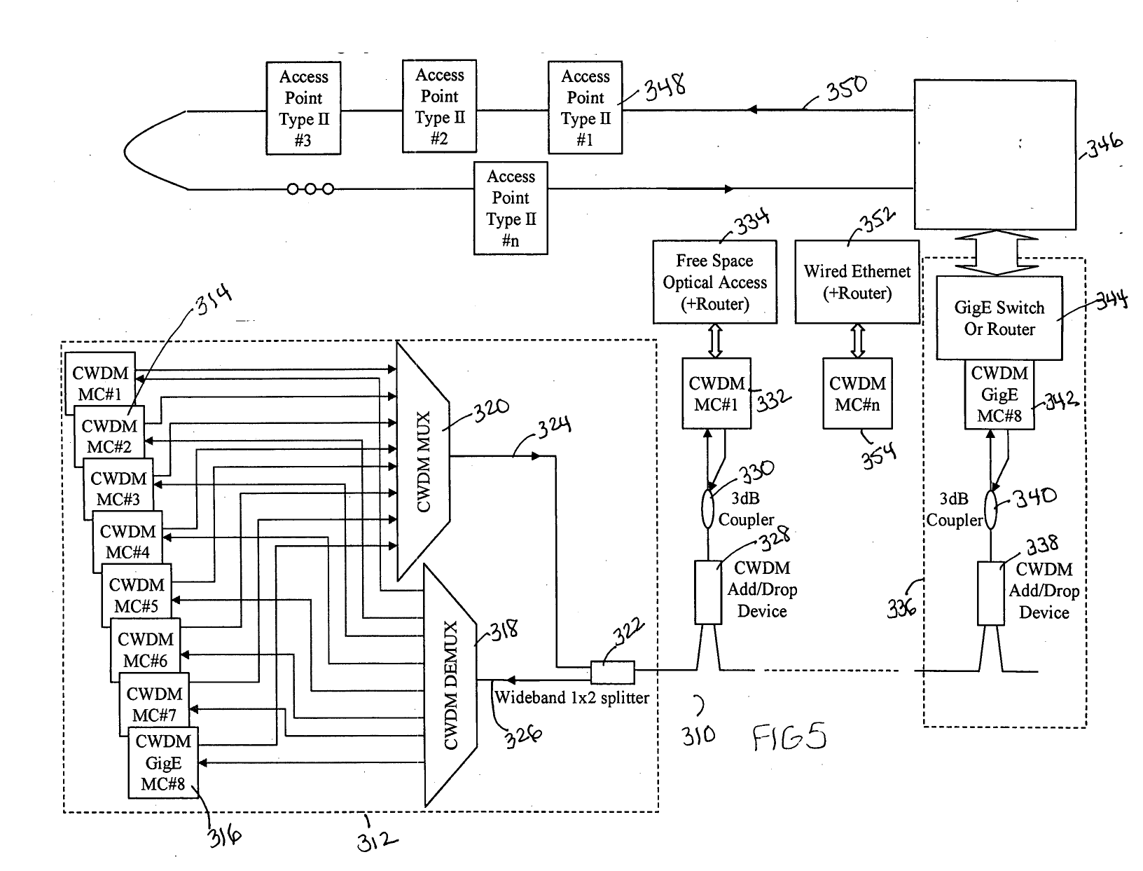

In another embodiment of the present invention, illustrated in FIG. 5, an optical wireless access system 310 includes a central office mux 312. Central office mux 312 includes a plurality of CWDM converters 314 and at least one CWDM GigE converter 316. A CWDM demux 318 coupled to at least a portion of the plurality of the CWDM converters 314. A CWDM mux 320 is coupled to at least a portion of the plurality of the CWDM converters 314. CWDM GigE converter 316 is coupled to CWDM demux 318 or CWDM mux 320. An optical circulator or a wideband splitter 322 is coupled to CWDM demux 318 and CWDM mux 320 first and second fibers 324 and 326.

A first CWDM add/drop device 328 is coupled to optical circulator or wideband splitter 322 and to a first coupler 330. A first CWDM converter 332 is coupled to first coupler 330. A free space optical access assembly or a wireless access point 334 is coupled to CWDM converter 332.

Central office mux 312 can be coupled to an access point 336. Access point 336 includes a second CWDM add/drop device 338 which is coupled to a second coupler 340. A first CWDM GigE converter 342 is coupled to second coupler 340 and to a GigE switch or a GigE router 344 which is in turn coupled to a central office mux denoted as 346. Central office mux 346 can be system 210, 110, 10 and the like.

Central office mux 346 is coupled to a plurality of access points 348 with a single fiber 350 in a ring configuration. An Ethernet connection port 352 can be provided and coupled to a second CWDM converter 352. Access points can be wireless, free space and Ethernet ports.

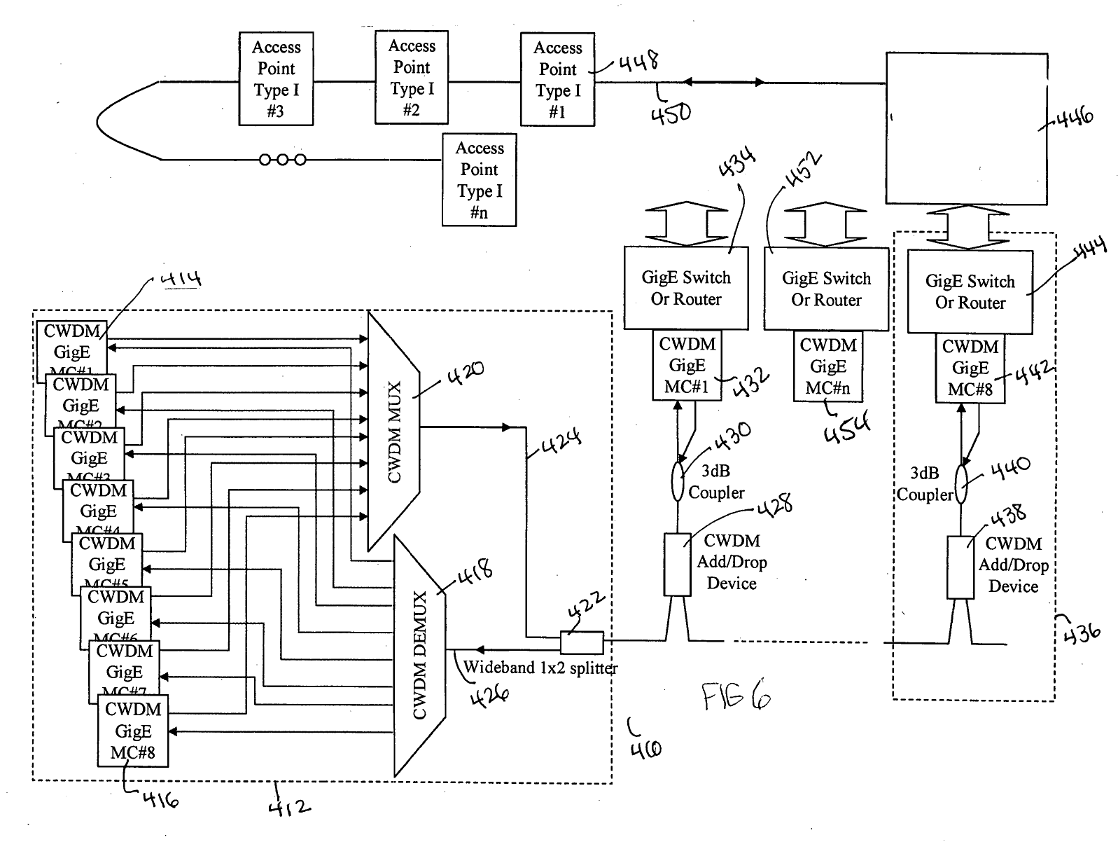

Referring now to FIG. 6, another embodiment of an optical wireless access system 410 of the present invention includes a central office mux 412 that has a plurality of CWDM converters 414 and at least one CWDM GigE converter 416. A CWDM demux 418 coupled to at least a portion of the plurality of the CWDM converters 414. A CWDM mux 420 is coupled to at least a portion of the plurality of the CWDM converters 414. CWDM GigE converter 416 is coupled to CWDM demux 418 and CWDM mux 420. An optical circulator or a wideband splitter 422 is coupled to CWDM demux 418 and CWDM mux 420 by first and second fibers 424 and 426.

A first CWDM add/drop device 428 is coupled to optical circulator or wideband splitter 422 and to a first coupler 430. A first CWDM GigE converter 432 is coupled to first coupler 430. A first GigE switch or router 434 is coupled to first CWDM GigE converter 432.

Central office mux 412 can be coupled to an access point 436. Access point 436 includes a second CWDM add/drop device 438 which is coupled to a second coupler 440. A second CWDM GigE converter 442 coupled to second coupler 440 and to a second GigE switch or a GigE router 444 which is in turn coupled to central office mux denoted as 436. Central office mux 446 can be system 210, 110, 10, and the like.

Central office mux 446 is coupled to a plurality of access points 448 with a single fiber 350. A third GigE switch or a GigE router 452 can be provided and coupled to a third CWDM GigE converter 452.

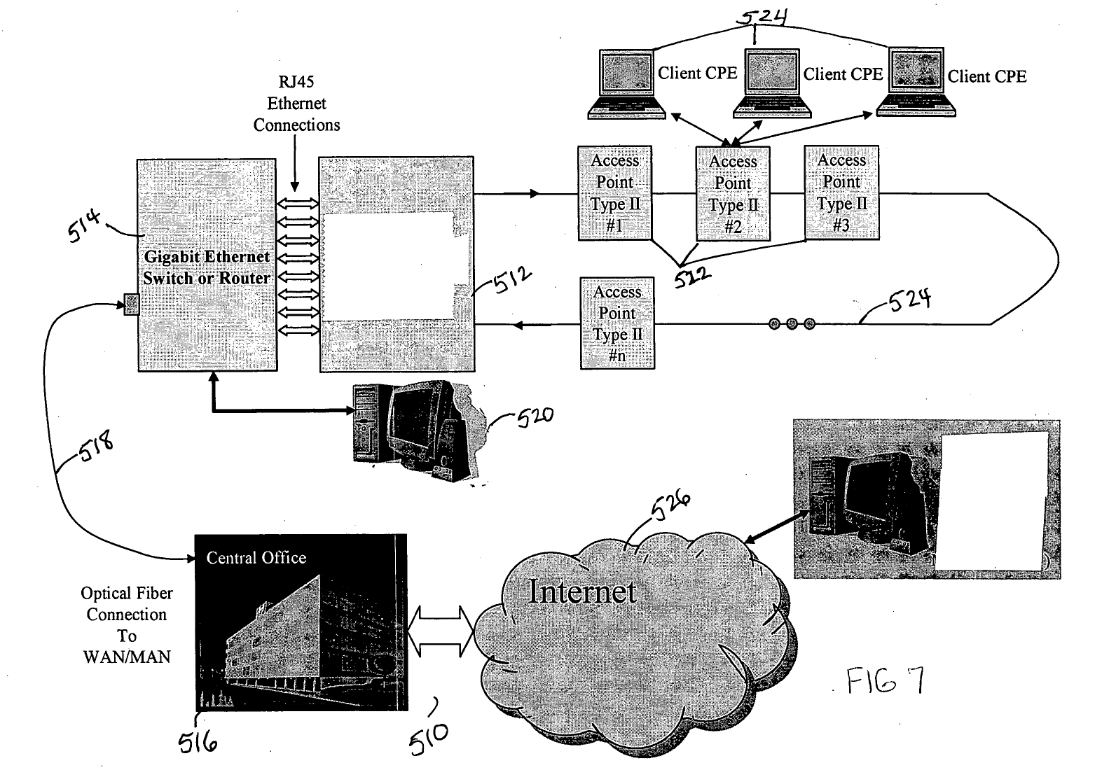

Systems 10, 110, 210, 310 and 410, collectively system 512, can be implemented in a variety of different deployment systems. FIG. 7, illustrates a deployment system 510 which includes system 512 coupled to a gigabit Ethernet switch or router 514 that is in turn connected to a carrier central office 516, which can be a node of a WAN/MAN, as well as any network equipment that provides high bandwidth connection to backbone networks, and the like. A fiber or a fiber pair 518 can couple gigabit Ethernet switch or router to carrier central office 516. Carrier central office 516 can be any entity that has leasing fat bandwidth pipes as one of their revenue sources, including but not limited to interexchange carriers, such as AT&T; baby Bells, such as SBC and SouthBell; CLEC, Cogent, ISP's, other independent carriers, and the like. A server 520 associated with carrier central office 516 is coupled to Ethernet switch or router 514 and can provide authentication, authorization, accounting, provisioning, monitoring and the like for deployment system 510. Numerous access points 522 can be coupled to client CPE's 524. Access points 522, which may be the same access points as in FIGS. 2 through 6, can be coupled by a single fiber 526 in a ring configuration. Carrier central office 516 can be coupled to the internet 526.

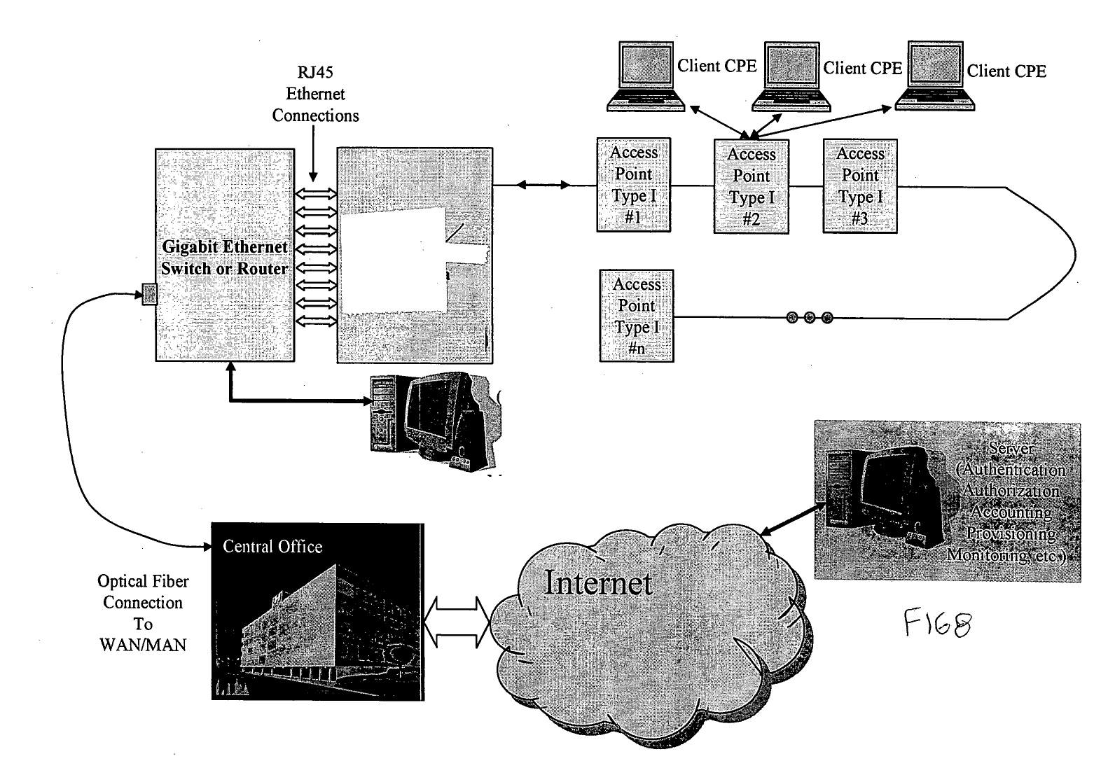

In the embodiment illustrated in FIG. 8, deployment system 610 includes all of the elements in the FIG. 7 embodiment. In this embodiment access points 522 are arranged in a non-ring configuration by single fiber 526.

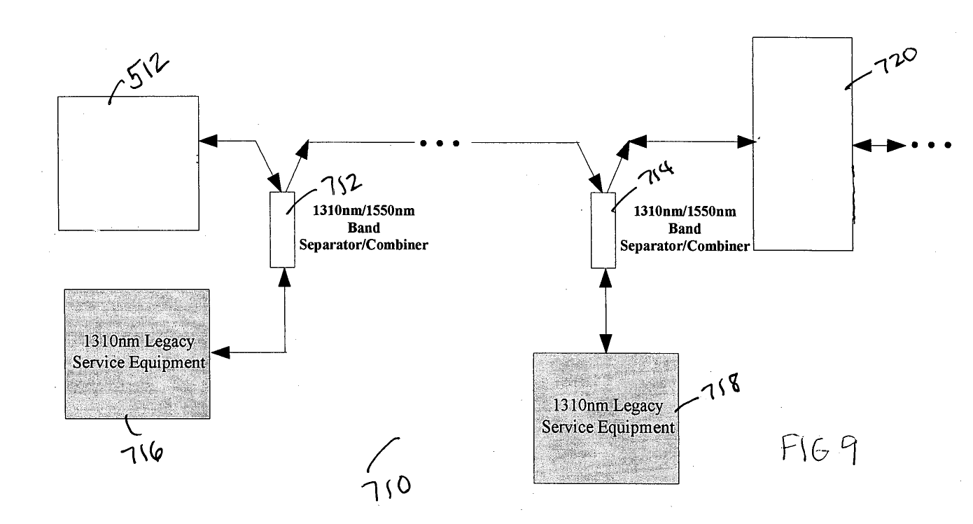

Referring now to FIG. 9, deployment system 710 includes system 512 coupled to a first passive optical element 712 which in turn is coupled to a second optical element 714. First and second optical elements can be band separator/combiners, and the like. Band separator/combiners 712 and 714 can in one embodiment be separate and combine a variety of different wavelengths, including but not limited to 1310/1550 nm, 850 nm, as well as other wavelengths. First and second optical elements 712 and 714 are each coupled to legacy service equipment 716 and 718, which can be for 1310 nm, 850 nm, and the like. Second optical element 714 is coupled to an access point 720. Third and fourth optical elements 722 and 724, which can also be for 1310 nm, are also provided. In the FIG. 9 embodiment, deployment system 710 provides broadband wireless access service with a single fiber. It will be appreciated that more than one fiber can be utilized.

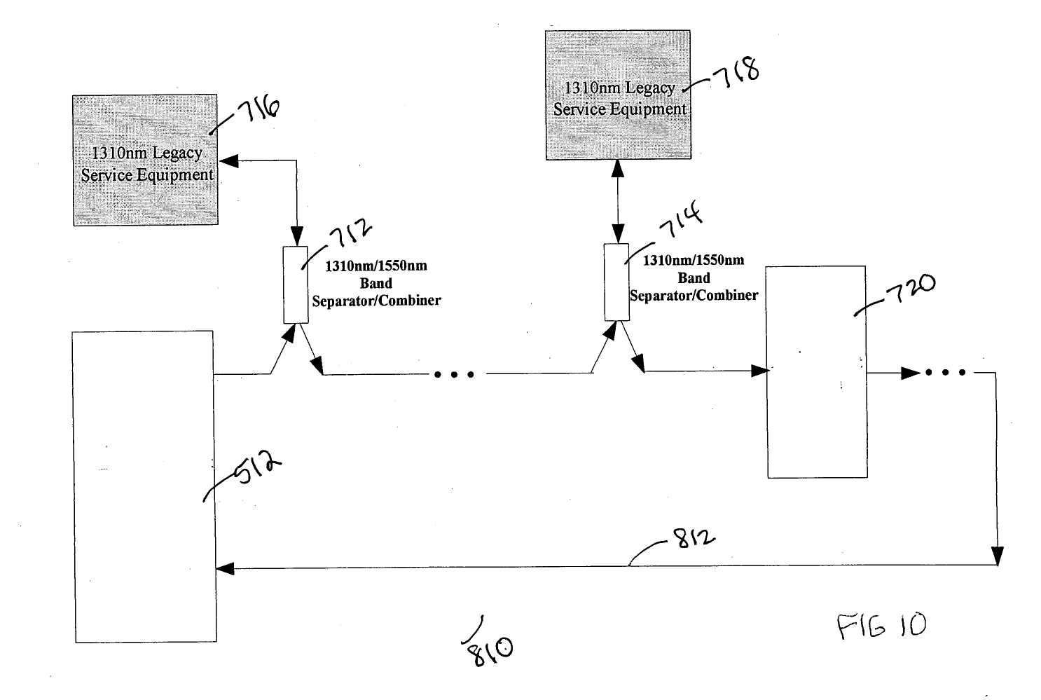

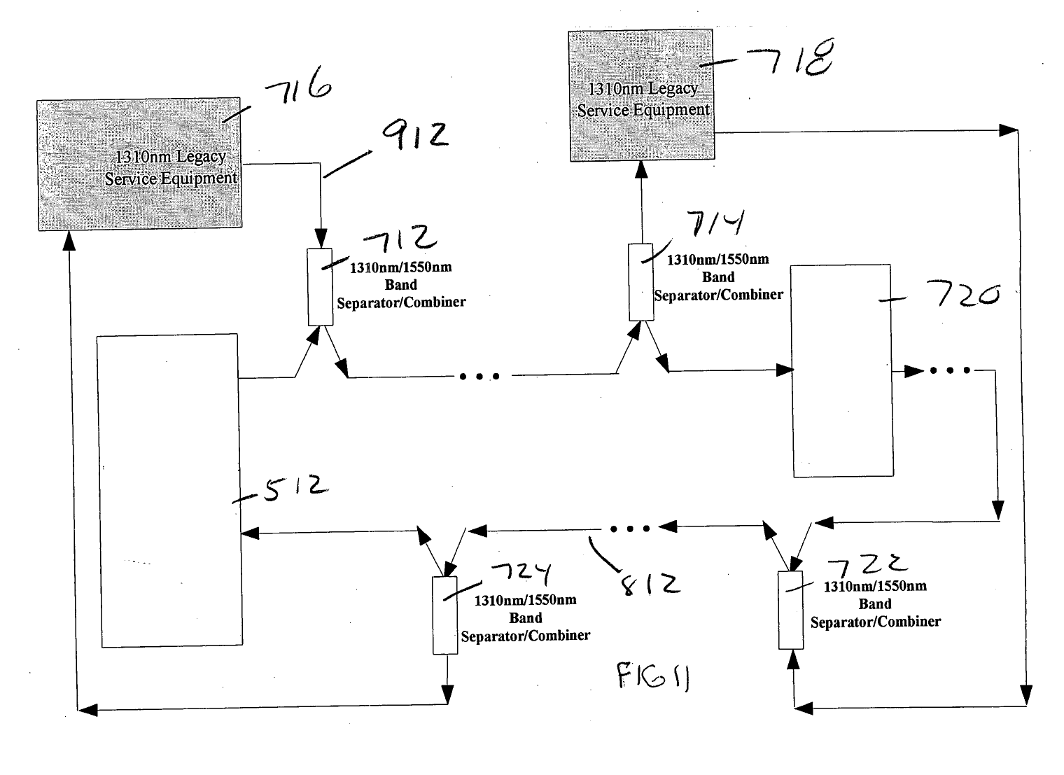

The FIG. 10 deployment system 810 is similar to FIG. 9 except it includes a single a ring 812. The FIG. 11 deployment system 910 is similar to FIG. 9 except a second fiber 912 is provided.

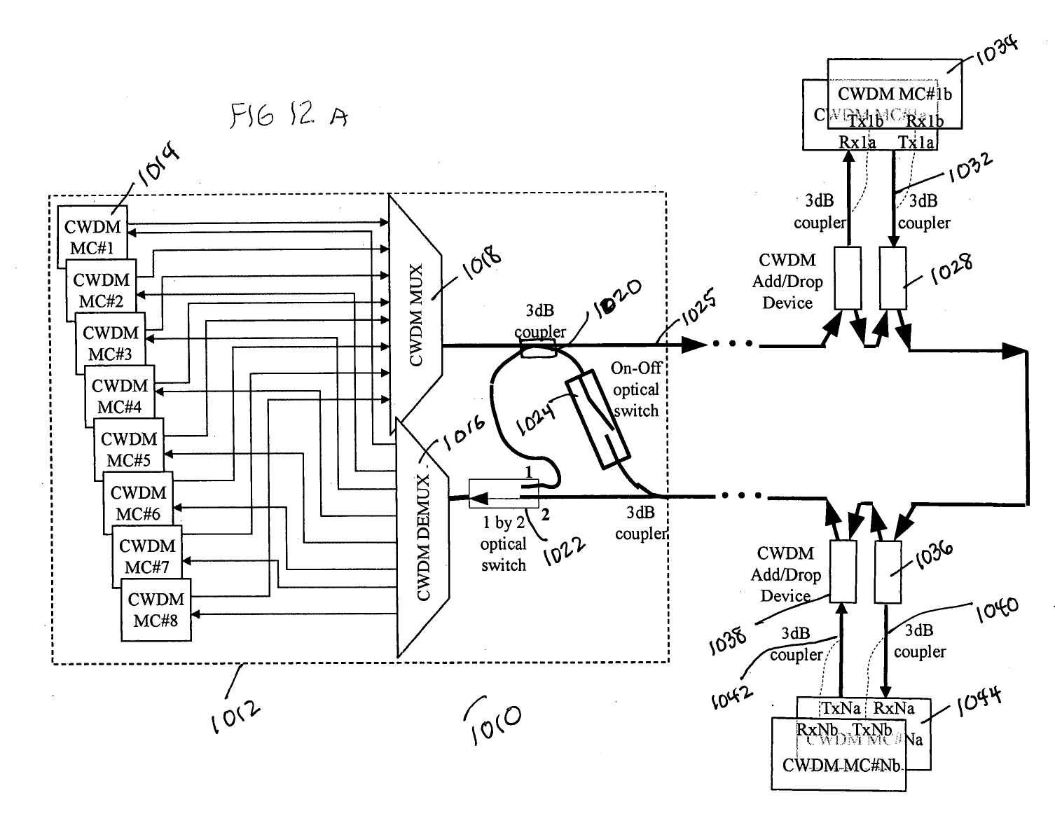

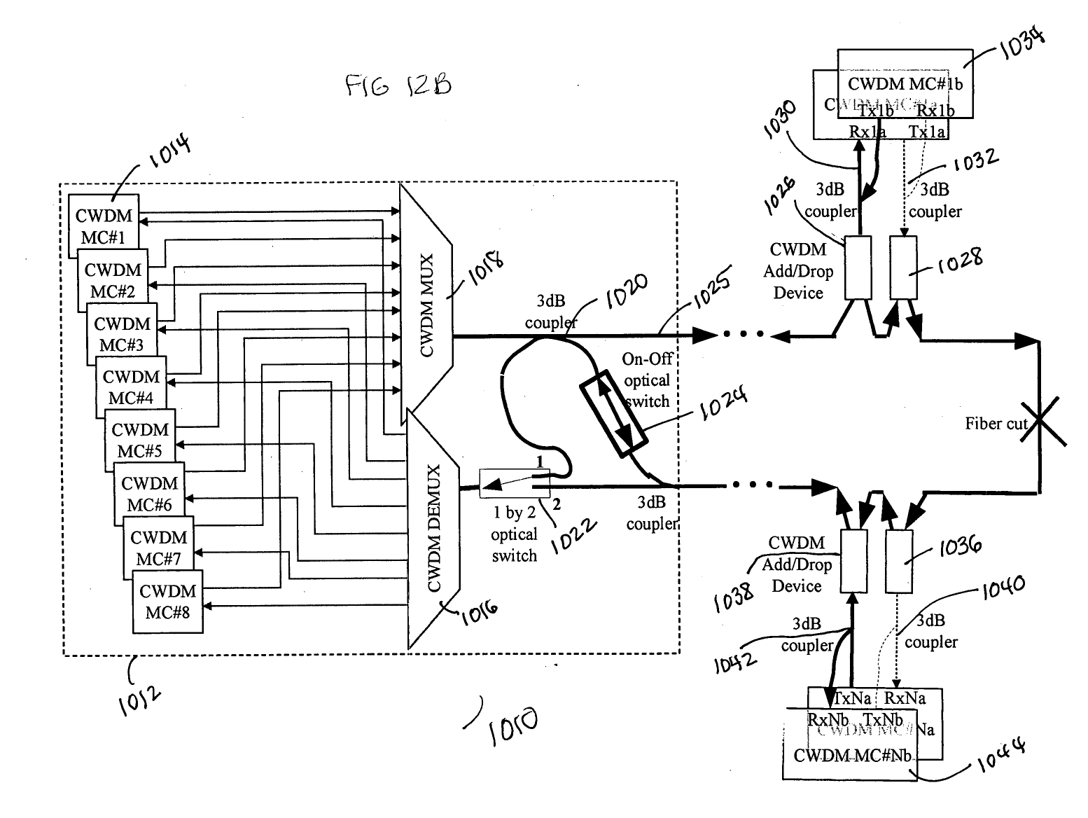

FIG. 12(a) illustrates an embodiment of the present invention with fiber cut backup. System 1010 includes a central office mux 1012 that has a plurality of CWDM converters 1014. A CWDM demux 1016 is coupled to at least a portion of the plurality of the CWDM converters 1014. A CWDM mux 1018 is coupled to at least a portion of the plurality of the CWDM converters 1014. A coupler 1020 is coupled to CWDM mux 1018, and an optical switch 1022, which can be a 1×2 optical switch, is coupled to CWDM demux 1016. An on-off switch is coupled to coupler 1020. An optical fiber 1025 is coupled to a first CWDM add/drop device 1026, and a second CWDM add/drop device 1028, which in turn are coupled to couplers 1030 and 1032 respectively.

Couplers 1030 and 1032 are each coupled to CWDM MC boards 1034. Optical fiber 1025 is also coupled to CWDM add/drop devices 1036 and 1038, which in turn are coupled to couplers 1040 and 1042 respectively. Couplers 1040 and 1042 are each coupled to CWDM MC boards 1044. During normal operation of system 1010, on-off switch 1024 is at an off state. Optical switch 1022 is at the position 2. At the access node, the backup media converter is off. Signals travel along fiber 1025, which is a fiber ring, unidirectionally. CWDM MC boards 1034 and 1044 have the intelligence to handle optical switches, primary media converters and backup media converters.

FIG. 12(b) illustrates that when fiber 1025 breaks optical switch 1024 is at the on state. Optical switch is at position 1. At the access node, the primary and backup media converters are at the states as indicated at one side of the fiber cut only the primary receiver and the backup transmitter work. At the other side of the fiber cut, only the primary transmitter and the backup receiver work. The optical signals travel bi-directionally along fiber 1025 at both ends of the cut. Intelligence resides on the system boards that accommodate CWDM MC boards 1034 and 1044.

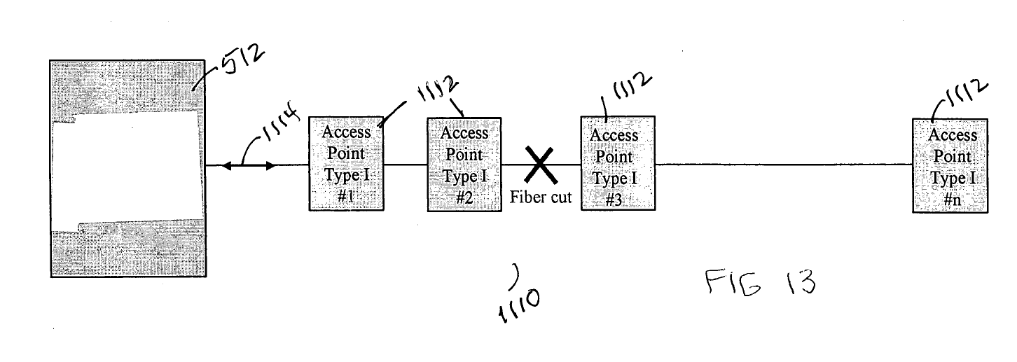

FIG. 13 illustrates an embodiment of the present invention with a single fiber system 1110. All access points 1112 are wireless access points. At the condition that every access point is reachable from adjacent access points wireless, and fiber 1114 is cut, for example between access points number 2 and number 3, then access points number 2 through number n can form a wireless distribution system. Ali of the subscribers are still on line. However, the bandwidths are reduced. The total possible aggregate bandwidth of all access points from number 2 through number n is less than 100 Mbps.

Ethernet connection ports 42, 142, 240 and 352 provide at least one of, direct 10BaseT, 100BaseT or 1000BaseT Ethernet connection ports and necessary IP functions.

CWDM converters 14, 28, 38, 44, 128, 144, 138, 226, 242, 236, 332, and 354 can each be a 10/100BASE-TX to 10/100Base-FX Media converter. Each CWDM converters described above can each be a 100 Mbps Ethernet to fiber optic media converter with a transmitter having one of the CWDM wavelengths. In one embodiment, the CWDM wavelengths are selected from at least one of, 1270, 1290, 1310, 1330, 1350, 1370, 1390, 1410, 1430, 1450, 1470, 1490, 1510, 1530, 1550, 1570, 1590 and 1610 nm. In another embodiment, the CWDM wavelengths are selected from at least one of 1271, 1291, 1311, 1331, 1351, 1371, 1391, 1411, 1431, 1451, 1471, 1491, 1511, 1531, 1551, 1571, 1591 and 1611 nm. There are no duplicate wavelengths in one group.

Couplers 26, 36 126, 136, 330, 340 430, 440 1020, 1030, 1032, 1036 and 1038 can each be a 3 dB coupler.

Wireless access points 30, 140 and 228 can each be a 802.11 b/g/a/wireless access point with routing functionality, a 802.16 wireless access point with routing functionality, and the like. Wireless access points 30, 140 and 228 perform at least one of, access provisioning, bandwidth management, account and billing, VLAN, security, networking functionality, and the like.

Free space optical access assemblies 40, 130, 238 and 334 implement at least one of a repeater, bridge, high bandwidth access, Ip routing, managements, and the like.

A plurality of systems 10, 110, 210 and 310 can provide data services, from lower data rates including but not limited to 256 kbps up to 100 Mbps, to over a hundred S&M business customers economically with fast provisioning. The total aggregate bandwidth can be more than 1 Gbps. With systems 10, 110, 210 and 310 free space access assembly 40, 130, 238, and 334, wireless access points 30, 140 and 228, and Ethernet connection ports 42, 142, 240 and 352, can be deployed simultaneously in one system. Systems 10, 110, 210 and 310 are suitable VoIP, video streaming, video on demand, and the like.

The fiber ring structure of system 210 provides a path that enables systems to be upgraded to one that has fiber cut restoration capability. System 310 provides a way to extend access points 348 from 16 to 32. System 410 can provide a method to extend the number of access points to 256, and can be utilized as an alternative candidate for the fiber to the home solution. Systems 510 and 610 can be complete independent access system that can provide provisioning, bandwidth management, authentication, authorization, accounting, billing, and the like. The only need outside of systems 510 and 610 is access to a fat pipe that connects to the backbone internetwork.

Systems 710, 810 and 910 add new wireless broadband services onto the same fiber that existing legacy systems currently use. The different embodiments of systems 710, 810 and 919 accommodate different legacy systems 716 and 718. By way of illustration, and without limitation, if a legacy system 716 and/or 718 uses single fiber to transport signals bi-directionally, system 710 can also use the single fiber configuration to transport wireless access services, including but not limited to systems 10, 110 and the like. System 810 uses a fiber ring structure to transport wireless access services. In this embodiment, legacy systems 716 and/or 718 can have one fiber and another is needed to form a closed fiber loop. System 910 uses the fiber ring structure to transport wireless access services. In this embodiment legacy systems 716 and 718 use two fibers for signal transportation.

Systems 710, 810 and 910 mux all of the CWDM signals together, and the CWDM signals are then combined with the 1310 nm legacy signal by first and second passive optical elements 712 and 714. All of the signals are then transported through the existing fiber. At the destination, first and second passive optical elements 7132 and 714 separate the 1310 nm legacy signal from the CWDM signals. On the reverse direction, this procedure is repeated reversibly.

The systems of the present invention bridge WiFi/WIMAX with high capacity fiber networks using CWDM at cost savings.

GigE switches and routers 344, 434, 452 and 444 deliver data packets to the right destination regardless of whether the data comes from the GigE port or from every access point, such as 100 Mbps ports. GigE switches and routers 344, 434, 452 and 444 aggregate the bandwidth from the access points to form a fat pipe so that the data can be transported on higher level backbone networks. GigE switches and routers 344, 434, 452 and 444 can also do much more, including but not limited to bandwidth management, fire walling, and the like, as well as connecting systems 10, 110, 210, 310 and the like.

While the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention.

1. An optical access system, comprising:
a plurality of CWDM converters;
a CWDM demux coupled to at least a portion of the plurality of the CWDM converters;
a CWDM mux coupled to at least a portion of the plurality of the CWDM converters;
an optical circulator or a wideband splitter coupled to the demux and the mux by a single fiber;
a first CWDM add/drop device coupled to the optical circulator or the wideband splitter and to a first coupler;
a first CWDM converter coupled to the first coupler; and
a wireless access point coupled to the CWDM converter.

2. The system of claim 1, wherein the coupler is a 3 dB coupler.

3. The system of claim 1, further comprising:
an access point including:
a second CWDM add/drop device coupled to the optical circulator or the wideband splitter and to a second coupler;
a second CWDM converter coupled to the second coupler; and
a free space optical access assembly coupled to the second CWDM converter.

4. The system of claim 1, further comprising:
an Ethernet connection port coupled to a third CWDM converter.

5. The system of claim 1, wherein each of a CWDM converter is a 10/100BASE-TX to 10/100Base-FX Media converter.

6. The system of claim 5, wherein each of a CWDM converter is a 10/100 Mbps Ethernet to fiber optic media converter with a transmitter having one of the CWDM wavelengths.

7. The system of claim 6, wherein the wavelengths are selected from at least one of, 1270, 1290, 1310, 1330, 1350, 1370, 1390, 1410, 1430, 1450, 1470, 1490, 1510, 1530, 1550, 1570, 1590 and 1610 nm.

8. The system of claim 6, wherein the wavelengths are selected from at least one of 1271, 1291, 1311, 1331, 1351, 1371, 1391, 1411, 1431, 1451, 1471, 1491, 1511, 1531, 1551, 1571, 1591 and 1611 nm.

9. The system of claim 7, wherein there are no duplicate wavelengths in one group.

10. The system of claim 1, wherein the wireless access point is a 802.11 b/g/a/wireless access point with routing functionality.

11. The system of claim 1, wherein the wireless access point is a 802.16 wireless access point with routing functionality.

12. The system of claim 10, wherein the wireless access point performs at least one of access provisioning, bandwidth management, account and billing, VLAN, security and networking functionality.

13. The system of claim 3, wherein the free space optical access provides a free space beam that operates in a point to point mode.

14. The system of claim 13, wherein the free space optical access provides a free space beam that operates in a point to point mode to implement at least one of a repeater, bridge, high bandwidth access, Ip routing and managements.

15. The system of claim 4, wherein the Ethernet connection port provides at least one of, direct 10 BaseT, 100BaseT or 1000BaseT Ethernet connection ports and necessary IP functions.

16. An optical access system, comprising:
a plurality of CWDM converters;
a CWDM demux coupled to at least a portion of the plurality of the CWDM converters;
a CWDM mux coupled to at least a portion of the plurality of the CWDM converters;
an optical circulator or a wideband splitter coupled to the demux and the mux by a single fiber;
a first CWDM add/drop device coupled to the optical circulator or the wideband splitter and to a first coupler;
a first CWDM converter coupled to the first coupler; and
a free space optical access assembly coupled to the CWDM converter.

17. The system of claim 16, wherein the coupler is a 3 dB coupler.

18. The system of claim 16, further comprising:
an access point including:
a second CWDM add/drop device coupled to the optical circulator or the wideband splitter and to a second coupler;
a second CWDM converter coupled to the second coupler; and
a wireless access point coupled to the second CWDM converter.

19. The system of claim 16, further comprising:
an Ethernet connection port coupled to a third CWDM converter.

20. The system of claim 16, wherein each of a CWDM converter is a 10/100BASE-TX to 10/100Base-FX Media converter.

21. The system of claim 20, wherein each of a CWDM converter is a 10/100 Mbps Ethernet to fiber optic media converter with a transmitter having one of the DWDM wavelengths.

22. The system of claim 21, wherein the wavelengths are selected from at least one of, 1270, 1290, 1310, 1330, 1350, 1370, 1390, 1410, 1430, 1450, 1470, 1490, 1510, 1530, 1550, 1570, 1590 and 1610 nm.

23. The system of claim 21, wherein the wavelengths are selected from at least one of 1271; 1291, 1311, 1331, 1351, 1371, 1391, 1411, 1431, 1451, 1471, 1491, 1511, 1531, 1551, 1571, 1591 and 1611 nm.

24. The system of claim 21, wherein there are no duplicate wavelengths in one group.

25. An optical access system, comprising:
a plurality of CWDM converters;
a CWDM demux coupled to at least a portion of the plurality of the CWDM converters;
a CWDM mux coupled to at least a portion of the plurality of the CWDM converters;
a first CWDM add/drop device coupled to the CWDM mux and the CWDM demux with a single fiber ring;
a second CWDM add/drop device coupled to the CWDM mux and the CWDM demux with the single fiber ring;
a first CWDM converter coupled to the first and second CWDM add/drop devices and a wireless access point.

26. The system of claim 25, wherein each of a CWDM converter is a 10/100BASE-TX to 10/100Base-FX Media converter.

27. The system of claim 26, wherein each of a CWDM converter is a 10/100 Mbps Ethernet to fiber optic media converter with a transmitter having one of the CWDM wavelengths.

28. The system of claim 27, wherein the wavelengths are selected from at least one of, 1270, 1290, 1310, 1330, 1350, 1370, 1390, 1410, 1430, 1450, 1470, 1490, 1510, 1530, 1550, 1570, 1590 and 1610 nm.

29. The system of claim 27, wherein the wavelengths are selected from at least one of 1271, 1291, 1311, 1331, 1351, 1371, 1391, 1411, 1431, 1451, 1471, 1491, 1511, 1531, 1551, 1571, 1591 and 1611 nm.

30. The system of claim 25, wherein there are no duplicate wavelengths in one group.

31. The system of claim 25, wherein the wireless access point is a 802.11b/g/a/wireless access point with routing functionality.

32. The system of claim 25, wherein the wireless access point is a 802.16 wireless access point with routing functionality.

33. The system of claim 25, wherein the wireless access point performs at least one of access provisioning, bandwidth management, account and billing, VLAN, security and networking functionality.

34. An optical access system, comprising:
a plurality of CWDM converters;
at least one CWDM GigE converter;
a CWDM demux coupled to at least a portion of the plurality of the CWDM converters;
a CWDM mux coupled to at least a portion of the plurality of the CWDM converters, the CWDM GigE converter being coupled to at least one of the CWDM demux or the CWDM mux;
an optical circulator or a wideband splitter coupled to the CWDM demux and the CWDM mux by first and second fibers;
a first CWDM add/drop device coupled to the optical circulator or the wideband splitter and to a first coupler;
a first CWDM converter coupled to the first coupler;
a free space optical access assembly or a wireless access point is coupled to the CWDM converter;
a second CWDM add/drop device coupled to the optical circulator or the wideband splitter and to a second coupler;
a first CWDM GigE converter coupled to the second coupler and to a GigE switch or a GigE router; and
a first optical access system coupled to the GigE switch or a GigE router.

35. The system of claim 34, wherein the first optical access system includes:
a plurality of CWDM converters;
a CWDM demux coupled to at least a portion of the plurality of the CWDM converters;
a CWDM mux coupled to at least a portion of the plurality of the CWDM converters;
an optical circulator or a wideband splitter coupled to the demux and the mux by a single fiber;
a first CWDM add/drop device coupled to the optical circulator or the wideband splitter and to a first coupler;
a first CWDM converter coupled to the first coupler; and
a free space optical access assembly coupled to the CWDM converter.

36. The system of claim 34, wherein the first optical access system includes:
a plurality of CWDM converters;
a CWDM demux coupled to at least a portion of the plurality of the CWDM converters;
a CWDM mux coupled to at least a portion of the plurality of the CWDM converters;
an optical circulator or a wideband splitter coupled to the demux and the mux by a single fiber;
a first CWDM add/drop device coupled to the optical circulator or the wideband splitter and to a first coupler;
a first CWDM converter coupled to the first coupler; and
a free space optical access assembly coupled to the CWDM converter.

37. The system of claim 34, wherein the first optical access system includes:
a plurality of CWDM converters;
a CWDM demux coupled to at least a portion of the plurality of the CWDM converters;
a CWDM mux coupled to at least a portion of the plurality of the CWDM converters;
a first CWDM add/drop device coupled to the CWDM mux and the CWDM demux with a single fiber ring;
a second CWDM add/drop device coupled to the CWDM mux and the CWDM demux with the single fiber ring;
a first CWDM converter coupled to the first and second CWDM add/drop devices and a wireless access point.

38. The system of claim 34, further comprising:
an Ethernet connection port coupled to a third CWDM converter.

39. The system of claim 38, wherein the Ethernet connection port provides at least one of, direct 10 BaseT, 100BaseT or 1000BaseT Ethernet connection ports and necessary IP functions.

40. The system of claim 34, wherein the CWDM GigE converter is a coarse wavelength division multiplexing 1000Base-TX to 1000Base-FX media converter.

41. The system of claim 34, wherein the CWDM GigE converter is a 1 Gbps Ethernet to fiber optic media converter with a transmitter having one of the CWDM wavelengths.

42. The system of claim 34, wherein each of a CWDM converter is a 10/100BASE-TX to 10/100Base-FX Media converter.

43. The system of claim 34, wherein each of a CWDM converter is a 10/100 Mbps Ethernet to fiber optic media converter with a transmitter having one of the CWDM wavelengths.

44. The system of claim 43, wherein the wavelengths are selected from at least one of, 1270, 1290, 1310, 1330, 1350, 1370, 1390, 1410, 1430, 1450, 1470, 1490, 1510, 1530, 1550, 1570, 1590 and 1610 nm.

45. The system of claim 43, wherein the wavelengths are selected from at least one of 1271, 1291, 1311, 1331, 1351, 1371, 1391, 1411, 1431, 1451, 1471, 1491, 1511, 1531, 1551, 1571, 1591 and 1611 nm.

46. The system of claim 43, wherein there are no duplicate wavelengths in one group.

47. The system of claim 34, wherein the wireless access point is a 802.11 b/g/a/wireless access point with routing functionality.

48. The system of claim 34, wherein the wireless access point is a 802.16 wireless access point with routing functionality.

49. The system of claim 34, wherein the wireless access point performs at least one of access provisioning, bandwidth management, account and billing, VLAN, security and networking functionality.

50. An optical access system, comprising:
a plurality of CWDM converters;
at least one CWDM GigE converter;
a CWDM demux coupled to at least a portion of the plurality of the CWDM converters;
a CWDM mux coupled to at least a portion of the plurality of the CWDM converters, the CWDM GigE converter being coupled to at least one of the CWDM demux or the CWDM mux;
an optical circulator or a wideband splitter coupled to the demux and the mux by first and second fibers;
a first CWDM add/drop device coupled to the optical circulator or the wideband splitter and to a first coupler;
a first CWDM GigE converter coupled to the first coupler;
a first GigE switch or router coupled to the first CWDM GigE converter;
a second CWDM add/drop device coupled to the optical circulator or the wideband splitter and to a second coupler;
a second CWDM GigE converter coupled to the second coupler and to a second GigE switch or a GigE router; and
a first optical access system coupled to the GigE switch or a GigE router.

51. The system of claim 50, wherein the first optical access system includes:
a plurality of CWDM converters;
a CWDM demux coupled to at least a portion of the plurality of the CWDM converters;
a CWDM mux coupled to at least a portion of the plurality of the CWDM converters;
an optical circulator or a wideband splitter coupled to the demux and the mux by a single fiber;
a first CWDM add/drop device coupled to the optical circulator or the wideband splitter and to a first coupler;
a first CWDM converter coupled to the first coupler; and
a free space optical access assembly coupled to the CWDM converter.

52. The system of claim 50, wherein the first optical access system includes:
a plurality of CWDM converters;
a CWDM demux coupled to at least a portion of the plurality of the CWDM converters;
a CWDM mux coupled to at least a portion of the plurality of the CWDM converters;
an optical circulator or a wideband splitter coupled to the demux and the mux by a single fiber;
a first CWDM add/drop device coupled to the optical circulator or the wideband splitter and to a first coupler;
a first CWDM converter coupled to the first coupler; and
a free space optical access assembly coupled to the CWDM converter.

53. The system of claim 50, wherein the first optical access system includes:
a plurality of CWDM converters;
a CWDM demux coupled to at least a portion of the plurality of the CWDM converters;
a CWDM mux coupled to at least a portion of the plurality of the CWDM converters;
a first CWDM add/drop device coupled to the CWDM mux and the CWDM demux with a single fiber ring;
a second CWDM add/drop device coupled to the CWDM mux and the CWDM demux with the single fiber ring;
a first CWDM converter coupled to the first and second CWDM add/drop devices and a wireless access point.

54. The system of claim 50, further comprising:
a third GigE switch or router coupled to a third CWDM GigE converter.

55. The system of claim 52, wherein each CWDM GigE converter is a coarse wavelength division multiplexing 1000Base-TX to 1000Base-FX media converter.

56. The system of claim 52, wherein each CWDM GigE converter is a 1 Gbps Ethernet to fiber optic media converter with a transmitter having one of the CWDM wavelengths.

57. The system of claim 50, wherein each of a CWDM converter is a 10/100BASE-TX to 10/100Base-FX Media converter.

58. The system of claim 50, wherein each of a CWDM converter is a 10/100 Mbps Ethernet to fiber optic media converter with a transmitter having one of the CWDM wavelengths.

59. The system of claim 50, wherein the wavelengths are selected from at least one of, 1270, 1290, 1310, 1330, 1350, 1370, 1390, 1410, 1430, 1450, 1470, 1490, 1510, 1530, 1550, 1570, 1590 and 1610 nm.

60. The system of claim 50, wherein the wavelengths are selected from at least one of 1271, 1291, 1311, 1331, 1351, 1371, 1391, 1411, 1431, 1451, 1471, 1491, 1511, 1531, 1551, 1571, 1591 and 1611 nm.

61. The system of claim 50, wherein there are no duplicate wavelengths in one group.

62. The system of claim 50, wherein the wireless access point is a 802.11 b/g/a/wireless access point with routing functionality.

63. The system of claim 50, wherein the wireless access point is a 802.16 wireless access point with routing functionality.

64. The system of claim 50, wherein the wireless access point performs at least one of access provisioning, bandwidth management, account and billing, VLAN, security and networking functionality.
